(19) United States
(12) Patent Application Publication
(10) Pub. No.: US 2022/0017836 A1
(43) Pub. Date: Jan. 20, 2022

(54) GREASE COMPOSITION FOR TAPERED ROLLER BEARING

(71) Applicant: KYODO YUSHI CO., LTD., Fujisawa-shi, Kanagawa (JP)

(72) Inventors: Kazuki ISA, Fujisawa-shi, Kanagawa (JP); Yuki TAKEYAMA, Chigasaki-shi, Kanagawa (JP); Yuta SATO, Lyon (FR)

(73) Assignee: KYODO YUSHI CO., LTD., Fujisawa-shi, Kanagawa (JP)

(21) Appl. No.: 17/295,672

(22) PCT Filed: Nov. 21, 2019
(86) PCT No.: PCT/JP2019/045618

§ 371 Date: May 20, 2021

(30) Foreign Application Priority Data
Nov. 21, 2018 (JP) 2018-218351

(51) Int. Cl. C10M 169/00; C10M 115/08; C10M 117/08; C10M 135/10; C10M 125/10; C10M 133/12; C10M 141/08; F16C 19/36; F16C 33/66

(52) U.S. Cl. CPC C10M 169/00; C10N 2050/10; C10M 117/08; C10M 135/10; C10M 125/10; C10M 133/12; C10M 141/08; F16C 19/36; F16C 33/6633; C10M 2203/003; C10M 2215/1026; C10M 2207/1446; C10M 2219/044; C10M 2215/26; C10M 2201/062; C10M 115/08

(57) ABSTRACT

A grease composition for a tapered roller bearing comprising: (a) at least one compound selected from the group consisting of metallic salts each having a metallic group having a valence of 2 as an additive; (b) a base oil containing a synthetic oil having a viscosity index of 110 or more and a pour point of −35° C. or less in an amount of 40% or more of the entire base oil; (c) a thickener; and (d) an antioxidant.

### TECHNICAL FIELD

The present invention relates to a grease composition and a tapered roller bearing using the grease composition.

### BACKGROUND ART

Grease compositions used as lubricants for use in rolling-element bearings such as tapered roller bearings generally contain three components, a thickener, a base oil, and an additive. For example, tapered roller bearings are used widely as bearings for supporting axles of vehicles typified by railroad vehicles and automobiles. For example, rolling-element bearings for supporting axles of automobiles include ball-type hub units using balls as rolling elements and tapered-type hub units using tapered rollers, and tapered-type hub units and tapered roller bearings using tapered rollers are applied to automobiles having large vehicle-body masses such as large-sized vehicles typified by SUVs and pickup trucks and commercial trucks in order to support larger loads, as described in Non Patent Literature 1 and Non Patent Literature 2. However, in the case where tapered-type hub units and tapered roller bearings are used, although a larger load can be supported, these tapered-type hub units and tapered roller bearings have more portions of sliding lubrication typified by lubrications between roller end faces and flanges and between rollers and cage than ball-type hub units, there arise problems of wear and peeling.

In addition, as described in Non Patent Literature 3, there is an increasing demand for reduction in torque for tapered roller bearings used in transmissions and the like, in order to improve the fuel consumptions of automobiles. However, tapered-type bearings have higher bearing torques than ball-type bearings and thus have issues in reduction in torque.

Moreover, expansion of the environments for use causes the operating temperature to expand even to lower temperatures and is increasing a demand for a low-temperature performance associated with the low-temperature fluidity of lubricants, such as fretting wears, which occur at the time of railway transport under low temperature environments, and cold start performances, and the like.

Hence, it is necessary for grease compositions that are applied to tapered-type hub units and tapered roller bearings using tapered rollers to be capable of improving wear resistances, torque reductions, and low-temperature performances.

As a grease composition made with durability and anti-fretting wear of tapered-type hub units and tapered roller bearings using tapered rollers taken into consideration, a grease that uses an aromatic diurea as the thickener, a mineral oil and/or a synthetic hydrocarbon oil as the base oil, and an organic molybdenum compound as the additive has been proposed (Patent Literature 1). Patent Literature 1 however fails to mention the torque reduction and the low-temperature performance. In addition, as a grease composition that suppresses the fretting wear under a low temperature environment, a grease composition that uses an alicyclic aliphatic diurea as the thickener, a mineral oil as the base oil, and an amine phosphate as the additive has been proposed (Patent Literature 2). Patent Literature 2 however fails to mention the cold start performance and also assumes that the rolling elements are not tapered rollers but balls for the fretting wear under a low temperature environment.

As described above, for grease compositions that are applied to tapered-type hub units and tapered roller bearings using tapered rollers, there are demands for wear resistance, torque reduction, and low-temperature performance in conjunction with the recent expansion of environments for use.

### CITATION LIST

### Patent Literature

Patent Literature 1: Japanese Patent Application Publication No. 2006-077056

Patent Literature 2: Japanese Patent Application Publication No. 2014-118467

### Non Patent Literature

Non Patent Literature 1: ZIDOUSYA GIJUTSU HANDOBUKKU, SEKKEI-HEN 2, DAI 7 SHO SASUPENSYON, ASUKURU, TAIYA, HOI-RU 7 (Automotive Technology Handbook, Design Edition, Chapter 7 Suspensions, Axles, Tires, Wheel, 7), pp. 496 to 501

Non Patent Literature 2: GEKKAN TORAIBOROGI-2006, 10 TOKUSYU ZIDOUSYA NO TORAIBOROGI-HABUYUNITTO BEARINGU NIOKERU TE-PA-RO-RA-BEARINGU NO GIJUTSU DOUKOU (Monthly Tribology 2006.10, Feature—Tribology of Automobiles, Technological Trend of Tapered Roller Bearings in Hub-unit Bearings), pp 44 to 45

Non Patent Literature 3: NSK Technical Journal No. 690 (2018) ENSUIKOROZIKUUKE NO TEIFURIKUSYON GIJUTSU (Low-Friction Technologies of Tapered Roller Bearings), pp 51 to 59

### SUMMARY OF INVENTION

### Problems to be Solved by the Invention

Hence, an object of the present invention is to provide a grease composition that exhibits excellent wear resistance, peel resistance, torque reduction, and low-temperature performance in a tapered roller bearing.

### Means for Solution of the Problems

1. A grease composition for a tapered roller bearing comprising:

(a) at least one compound selected from the group consisting of metallic salts each having a metallic group having a valence of 2 as an additive;

(b) a base oil containing a synthetic oil having a viscosity index of 110 or more and a pour point of −35° C. or less in an amount of 40% or more of the entire base oil;

(c) a thickener; and

(d) an antioxidant.

2. The grease composition for a tapered roller bearing according to the 1, wherein the component (a) is represented by the following formula (1) or (2):

[R4—SO₃]M¹ (1)

wherein R4 represents an alkyl group, an alkenyl group, an alkyl naphthyl group, a dialkyl naphthyl group, an alkyl phenyl group, and a petroleum high boiling point fraction residue, the alkyl or alkenyl is linear or branched and has 2 to 22 carbon atoms, and M¹ represents an alkaline earth metal or zinc, and

M²CO₃ (2)

wherein M² represents an alkaline earth metal or zinc.

3. The grease composition for a tapered roller bearing according to the 1 or 2, wherein the component (a) is at least one selected from the group consisting of organic calcium sulfonates, organic zinc sulfonates, calcium carbonate, and zinc carbonate.

4. The grease composition for a tapered roller bearing according to any one of the 1 to 3, wherein the synthetic oil contained in the component (b) is at least one selected from the group consisting of synthetic hydrocarbon oils.

5. The grease composition for a tapered roller bearing according to any one of the 1 to 4, wherein a kinematic viscosity of the synthetic oil contained in the component (b) at 40° C. is 15 to 5000 mm²/s, and

a kinematic viscosity of the entire component (b) at 40° C. is 20 to 300 mm²/s.

6. The grease composition according to any one of the 1 to 5, wherein the component (c) is at least one selected from the group consisting of urea compounds and Li soap-based compounds.

7. The grease composition for a tapered roller bearing according to the 6, wherein the urea compound is a diurea compound represented by the following formula (3):

R1—NHCONH—R2—NHCONH—R3 (3)

wherein R2 represents a divalent aromatic hydrocarbon group having 6 to 15 carbon atoms, R1 and R3 may be the same or different and each represent an alkyl group having 6 to 30 carbon atoms or a cyclohexyl group, and the proportion of the number of moles of the cyclohexyl groups to the total number of moles of the cyclohexyl groups and the alkyl groups [{(the number of the cyclohexyl groups)/(the number of the cyclohexyl groups+the number of the alkyl groups)}×100] is 0 to 90% by mol.

8. The grease composition for a tapered roller bearing according to the 6, wherein the Li soap-based compound is a Li complex that is a mixture of a lithium salt of at least one diprotic acid selected from succinic acid, malonic acid, adipic acid, pimelic acid, azelaic acid, and sebacic acid and a lithium salt of at least one aliphatic carboxylic acid.

9. The grease composition according to any one of the 1 to 8, wherein the (d) antioxidant contains at least one selected from the group consisting of amine-based antioxidants and phenol-based antioxidants.

10. The grease composition according to any one of the 1 to 9, wherein the antioxidant is at least one selected from the group consisting of alkyl diphenylamines, N-phenyl-α-naphthylamine, 3-(4′-hydroxy-3′,5′-di-tert-butylphenyl)propionic acid-n-octadecyl, 2,6-di-tertiary-butyl-p-cresol (BHT), 2,2′-methylenebis(4-methyl-6-tertiary-butylphenol), 4,4′-butylidenebis(3-methyl-6-tertiary-butylphenol), 2,6-di-tertiary-butyl-phenol, 2,4-dimethyl-6-tertiary-butylphenol, tertiary-butylated hydroxyanisole (BHA), 4,4′-butylidenebis(3-methyl-6-tertiary-butylphenol), 4,4′-methylenebis(2,3-di-tertiary-butylphenol), and 4,4′-thiobis(3-methyl-6-tertiary-butylphenol).

11. The grease composition for a tapered roller bearing according to any one of the 1 to 10, wherein a dropping point of the grease composition for a tapered roller bearing is 230° C. or more.

### Advantageous Effects of Invention

The grease composition of the present invention exhibits excellent wear resistance, peel resistance, torque reduction, and low-temperature performance in a tapered roller bearing.

### DESCRIPTION OF EMBODIMENTS

### (a) Additive

An additive used in the present invention includes at least one compound selected from the group consisting of metallic salts each having a metallic group having a valence of 2 as an essential component. The metallic salts may be salts of organic acids or inorganic acids.

The organic metallic salt having a metallic group having a valence of 2 is preferably a compound represented by the following formula (1):

[R4—SO₃]M¹ (1)

wherein R4 represents an alkyl group, an alkenyl group, an alkyl naphthyl group, a dialkyl naphthyl group, an alkyl phenyl group, and a petroleum high boiling point fraction residue, the alkyl or alkenyl is linear or branched and has 2 to 22 carbon atoms, and M¹ represents an alkaline earth metal or zinc. M¹ is preferably calcium or zinc, and more preferably calcium.

The metallic salt of an organic sulfonic acid used in the present invention may be a calcium salt or zinc salt of an alkyl benzenesulfonic acid, a calcium salt or zinc salt of dinonylnaphthalenesulfonic acid, or a highly basic salt of these. Among these, highly basic salts of calcium salts of alkyl benzenesulfonic acids and zinc salts of dinonylnaphthalenesulfonic acids are preferable.

The total base number (TBN) of the metallic salt of the organic sulfonic acid is preferably 0.1 to 500 mg KOH/g, more preferably 50 to 500 mg KOH/g, which is highly basic, and further preferably 300 to 500 mg KOH/g, from the viewpoint of wear resistance and torque reduction. Note that, in the case where 2 or more metallic salts of organic sulfonic acids are used together, the sum of the total base numbers of the multiple types is preferably within the above ranges.

In particular, it is preferable that a highly basic salt of a calcium salt of an alkyl benzenesulfonic acid having a TBN of 300 to 500 mg KOH/g be contained.

The content of the organic metallic salt is preferably 0.1 to 10% by mass, more preferably 0.3 to 7% by mass, and further preferably 0.5 to 4% by mass, of the grease composition.

The inorganic metallic salt having a metallic group having a valence of 2 is preferably a carbonate represented by the following formula (2):

M²CO₃ (2)

wherein M² represents an alkaline earth metal or zinc.

The carbonate having a metallic group having a valence of 2 is preferably at least one selected from the group consisting of calcium carbonate and zinc carbonate.

The content of the inorganic metallic salt is preferably 0.1 to 10% by mass, more preferably 0.5 to 7% by mass, and further preferably 1 to 6% by mass, of the grease composition.

The composition of the present invention preferably contains both of an organic metallic salt having a metallic group having a valence of 2 and an inorganic metallic salt having a metallic group having a valence of 2. In the case where the composition of the present invention contains both of an organic metallic salt having a metallic group having a valence of 2 and an inorganic metallic salt having a metallic group having a valence of 2, the total amount of these is preferably 0.2 to 10% by mass, more preferably 2 to 8% by mass, and further preferably 4 to 7% by mass, based on the total mass of the composition of the present invention.

### (b) Base Oil

The base oil used in the grease composition of the present invention contains a synthetic oil having a viscosity index of 110 or more and a pour point of −35° C. or less, as an essential component.

The viscosity index of the synthetic oil is more preferably 120 or more, further preferably 125 or more, and further preferably 130 or more, from the viewpoint of low-temperature performance and torque reduction.

The pour point of the synthetic oil is preferably −35° C. or less, more preferably −40° C. or less, further preferably −50° C. or less, and particularly preferably −60° C. or less, from the viewpoint of low-temperature performance.

The proportion of the synthetic oil in the base oil containing the synthetic oil is 40% by mass or more, from the viewpoint of low-temperature performance. The proportion is more preferably 50% by mass or more, further preferably 60% by mass or more, and particularly preferably 80% by mass or more.

The viscosity index of the entire base oil is preferably 100 or more, more preferably 110 or more, and further preferably 125 or more, from the viewpoint of wear resistance, peel resistance, and torque reduction.

The pour point of the entire base oil is preferably −20° C. or less, more preferably −30° C. or less, further preferably −35° C. or less, further more preferably −40° C. or less, particularly preferably −50° C. or less, and most preferably −60° C. or less, from the viewpoint of low-temperature performance.

The kinematic viscosity of the synthetic oil at 40° C. is preferably 15 to 5000 mm²/s, more preferably 15 mm²/s to 1000 mm²/s, and further preferably 15 to 400 mm²/s, from the viewpoint of low-temperature performance and torque reduction.

The kinematic viscosity of the entire base oil at 40° C. is preferably 20 to 300 mm²/s, more preferably 30 to 200 mm²/s, further preferably 30 to 100 mm²/s, and particularly preferably 50 to 80 mm²/s, from the viewpoint of wear resistance, peel resistance, and torque reduction.

The synthetic oil in the base oil containing the synthetic oil preferably contains at least one selected from an ether-based synthetic oil, an ester-based synthetic oil, and a synthetic hydrocarbon oil.

A synthetic hydrocarbon oil is more preferable from the viewpoint of torque reduction and low-temperature performance.

As the ether-based synthetic oil, an alkyl diphenyl ether-based synthetic oil is preferable.

The ester-based synthetic oil includes all ester-based synthetic oils such as monoesters, diesters, polyolesters, and complex esters. One of them may be used alone, or two or more ester-based synthetic oils may be blended as appropriate. In particular, a polyolester is preferable. As the polyolester, an ester of a neopentyl-type polyol such as trimethylolpropane, pentaerythritol, or dipentaerythritol with an aliphatic, linear or branched, saturated or unsaturated monocarboxylic acid having 2 to 36 carbon atoms is preferable. Specifically, such polyolester includes an ester of a neopentyl-type polyol such as trimethylolpropane, pentaerythritol, or dipentaerythritol with an aliphatic, linear or branched monocarboxylic acid having 2 to 36 carbon atoms such as n-ethanoic acid, n-propanoic acid, n-butanoic acid, n-pentanoic acid, 2-methylpentanoic acid, 2-ethylpentanoic acid, n-hexanoic acid, 2-methylhexanoic acid, 2-ethylhexanoic acid, n-heptanoic acid, n-octanoic acid, n-nonanoic acid, n-decanoic acid, n-undecanoic acid, n-dodecanoic acid, n-tridecanoic acid, n-tetradecanoic acid, n-pentadecanoic acid, n-hexadecanoic acid, n-heptadecanoic acid, or n-octadecanoic acid. An ester obtained by reacting one neopentyl-type polyol with multiple fatty acids is preferable. At least one of the multiple fatty acids is preferably a branched fatty acid. In particular, an ester of pentaerythritol with a fatty acid mixture of linear or branched fatty acids having 7 to 10 carbon atoms or an ester of dipentaerythritol with a mixture of linear or branched fatty acids having 7 to 10 carbon atoms is preferable. Further in particular, an ester of pentaerythritol with a mixture of 2-methylhexanoic acid, n-heptanoic acid, and n-octanoic acid is preferable.

As the synthetic hydrocarbon oil, poly-α-olefin, polybutene, and ethylene-α-olefin copolymer are preferable.

The synthetic oil contained in the base oil of the present invention is preferably made of only poly-α-olefins from the viewpoint of wear resistance, peel resistance, and torque reduction. Among these, the synthetic oil is preferably made of only poly-α-olefins having a viscosity index of 125 or more from the viewpoint of low-temperature performance. Particularly, the synthetic oil is preferably made of only poly-α-olefins having a viscosity index of 125 or more and a pour point of −60° C. or less.

The proportion of the base oil in the composition of the present invention is preferably 70% by mass or more, more preferably 75 to 90% by mass, and further preferably 75 to 85% by mass.

The base oil in the composition of the present invention is not particularly limited as long as the base oil essentially contains a synthetic oil, and 2 or more synthetic oils may be used together, and a mineral oil may be used together.

### (c) Thickener

The thickener used in the grease composition of the present invention is not particularly limited. Preferable examples include urea-based thickeners typified by diurea, Li soap-based thickeners typified by Li soaps and Li-complex soaps, inorganic thickeners typified by organoclay and silica, and organic thickeners typified by PTFE. An urea-based thickener and a Li soap-based thickener are particularly preferable.

As the urea-based thickener, a diurea compound represented by the following formula (3) is preferable:

R1—NHCONH—R2—NHCONH—R3 (3)

wherein R2 represents a divalent aromatic hydrocarbon group having 6 to 15 carbon atoms, R1 and R3 may be the same or different and each represent an alkyl group having 6 to 30 carbon atoms or a cyclohexyl group, and the proportion of the number of moles of the cyclohexyl groups to the total number of moles of the cyclohexyl groups and the alkyl groups [{(the number of the cyclohexyl groups)/(the number of the cyclohexyl groups +the number of the alkyl groups)}×100] is 0 to 90% by mol. R2 is preferably tolylene diisocyanate or diphenylmethane diisocyanate, and more preferably diphenylmethane diisocyanate.

The proportion of the number of moles of the cyclohexyl groups to the total number of moles of the cyclohexyl groups and the alkyl groups [{(the number of the cyclohexyl groups)/(the number of the cyclohexyl groups+the number of the alkyl groups)}×100] is preferably 0 or 50 to 90% by mol, more preferably 50 to 90% by mol, further preferably 70 to 90% by mol, and particularly preferably 80 to 90% by mol.

The alkyl group having 6 to 30 carbon atoms is preferably at least one the number of carbon atoms of which is selected from 8 and 18.

The diurea compound of the formula (3) can be obtained, for example, by reacting a certain diisocyanate and a certain monoamine in a base oil. Preferable specific examples of the diisocyanate include diphenylmethane-4,4′-diisocyanate and tolylene diisocyanate. The monoamine includes aliphatic amines, alicyclic amines, and mixtures of these. Specific examples of the aliphatic amines include octylamine, nonylamine, decylamine, undecylamine, dodecylamine, tridecylamine, tetradecylamine, pentadecylamine, hexadecylamine, heptadecylamine, octadecylamine, nonyldecylamine, eicodecylamine, and oleylamine. Specific examples of the alicyclic amines include cyclohexylamine and dicyclohexylamine. The reaction product of a diisocyanate and an aliphatic amine is referred to as an aliphatic diurea (that is, a compound in which the number of moles of cyclohexyl groups is 0% in the formula (3)). The reaction product of a diisocyanate and a mixture of an aliphatic amine and an alicyclic amine is referred to as an alicyclic aliphatic diurea (that is, a compound in which the number of moles of cyclohexyl groups exceeds 0% and 90% or less in the formula (3)). As the diurea-based thickener of the present invention, an alicyclic aliphatic diurea is preferable.

As the Li soap, lithium stearate and lithium 12-hydroxystearate are preferable, and lithium 12-hydroxystearate is more preferable.

The Li-complex soap includes a complex of a lithium salt of an aliphatic carboxylic acid such as stearic acid or 12-hydroxystearic acid and a lithium salt of a diprotic acid. The diprotic acid includes succinic acid, malonic acid, adipic acid, pimelic acid, azelaic acid, and sebacic acid. Azelaic acid and sebacic acid are preferable. The Li-complex soap is preferably a mixture of a lithium salt of at least one diprotic acid selected from succinic acid, malonic acid, adipic acid, pimelic acid, azelaic acid, and sebacic acid and a lithium salt of at least one aliphatic carboxylic acid. In particular, a Li-complex soap that is a mixture of a lithium salt of azelaic acid and a lithium salt of 12-hydroxystearic acid is preferable.

The content of the thickener in the grease composition of the present invention varies depending on the type of the thickener. The consistency of the grease composition of the present invention is preferably 200 to 400, and more preferably 250 to 350. The content of the thickener is an amount that is necessary to obtain this consistency. The content of the thickener is normally 3 to 30% by mass, preferably 5 to 25% by mass, and more preferably 7 to 15% by mass in the grease composition of the present invention. The dropping point of the grease composition of the present invention is preferably 200° C. or more, and more preferably 230° C. or more, from the viewpoint of heat resistance.

### (d) Antioxidant

Antioxidants are known as oxidation degradation inhibitors for grease. Antioxidants that can be used in the present invention include amine-based antioxidants and phenol-based antioxidants.

The amine-based antioxidants include alkyl diphenylamines (for example, a reaction product of N-phenylbenzenamine and 2,4,4-trimethylpentene), N-n-butyl-p-aminophenol, 4,4′-tetramethyl-diaminodiphenylmethane, α-naphthylamine, N-phenyl-α-naphthylamine, and phenothiazine. Alkyl diphenyl amines and N-phenyl-α-naphthylamine are preferable, and a reaction product of N-phenylbenzenamine and 2,4,4-trimethylpentene is more preferable.

The phenol-based antioxidants include n-octadecyl 3-(4′-hydroxy-3′,5′-di-t-butylphenyl) propionate, 2,6-di-tertiary-butyl-p-cresol (BHT), 2,2′-methylenebis(4-methyl-6-tertiary-butylphenol), 4,4′-butylidenebis(3-methyl-6-tertiary-butylphenol), 2,6-di-tertiary-butyl-phenol, 2,4-dimethyl-6-tertiary-butylphenol, tertiary-butylated hydroxyanisole (BHA), 4,4′-butylidenebis(3-methyl-6-tertiary-butylphenol), 4,4′-methylenebis(2,3-di-tertiary-butylphenol), and 4,4′-thiobis(3-methyl-6-tertiary-butylphenol). 3-(4′-hydroxy-3′,5′-di-tert-butylphenyl)propionic acid-n-octadecyl is preferable.

The content of the antioxidant is normally 0.1 to 10% by mass, preferably 0.5 to 5% by mass, and more preferably 1 to 4% by mass, relative to the total mass of the composition of the present invention, from the viewpoint of effects and economic efficiency.

The grease composition of the present invention may further contain various additives depending on necessity.

### Anticorrosive

Containing an anticorrosive makes it possible to provide a grease composition that does not rust or is unlikely to rust even when water is applied to the grease composition. As the anticorrosive, for example, amine-based anticorrosives, carboxylic acids and derivatives thereof; alkenyl succinic anhydrides, alkenyl succinic acid esters, alkenyl succinic acid half esters, carboxylic acid salts; amine salts of fatty acids, diprotic acids, naphthenic acid, lanolin fatty acids, and alkenyl succinic acids; passivators; sodium nitrite, sodium molybdate, and the like, esters; sorbitan trioleate and sorbitan monooleate, metal corrosion preventives; benzotriazole or derivatives thereof, zinc oxide, and the like are preferably used.

The content of the anticorrosive is normally 0.05 to 5% by mass, preferably 0.10 to 4 mass %, and more preferably 0.25 to 3 mass %, relative to the total mass of the composition of the present invention, from the viewpoint of effects and economic efficiency.

### Extreme Pressure Agent

Phosphorus-based compounds such as tricresyl phosphate, tri(2-ethylhexyl)phosphate, amine phosphates, triphenyl phosphorothioate, and derivatives thereof; sulfur-based compounds such as dibenzyl disulfide and various polysulfides; sulfur-phosphorus-based compounds such as triphenyl phosphorothionate; organic metal-based extreme pressure agents such as Zn, Mo, Sb, Bi or other metal salts of dialkyl dithiophosphoric acids, Zn, Mo, Sb, Ni, Cu, Bi or other metal salts of dialkyl dithiocarbamic acids, ashless dithiocarbamate or ashless dithiophosphate carbamate; solid lubricants such as molybdenum disulfide, graphite, PTFE, MCA, and the like.

The grease composition of the present invention preferably contains at least one selected from amine phosphate, triphenyl phosphorothioate and derivatives thereof, Zn and Mo of dialkyl dithiophosphoric acid, and Zn and Mo of dialkyl dithiocarbamic acid, and further preferably contains at least one selected from amine phosphates and a Mo salt of dialkyl dithiocarbamic acid. As the amine phosphate, a tertiary-alkyl-dimethyl phosphate is preferable. As the Mo salt of dialkyl dithiocarbamic acid, molybdenum dithiocarbamate (MoDTC) is preferable. As the amine phosphate, a commercial product such as Vanlube 672 (tertiary-alkylamine-dimethyl phosphate) manufactured by R. T. Vanderbilt can be utilized.

A preferable example of MoDTC can be represented by the following formula (4):

[R₅R₆N—CS—S]₂—MoOmSn (4)

wherein R₅ and R₆ may be the same or different and each independently represent a linear or branched alkyl group having 1 to 24 carbon atoms and preferably 3 to 18 carbon atoms, m is 0 to 3, n is 4 to 1, and m+n=4.

The content of the extreme pressure agent is a general amount, and is normally about 0.1 to 10% by mass relative to the entire grease composition. The content of the extreme pressure agent is preferably 0.3 to 5% by mass and more preferably 0.5 to 3% by mass.

### Applicable Parts

Mechanical parts for which the composition of the present invention is used are not particularly limited, but tapered roller bearings are preferable, and tapered roller bearings for use in axles of railroad vehicles and automobiles are particularly preferable.

### EXAMPLES

Grease compositions that contain alicyclic aliphatic diureas (Examples 1 to 12, Comparative Examples 1 to 4) as thickeners were prepared as follows. Predetermined amounts of raw material amines (cyclohexylamine and stearylamine, the molar ratio was cyclohexylamine:stearylamine=7:1) were reacted with 4.4′-diphenylmethane diisocyanate in a ratio of 2 moles of the raw material amines per mole of 4.4′-diphenylmethane diisocyanate in a base oil, followed by heating and cooling to obtain a base grease. Predetermined amounts of additives were mixed with the base oil, and the mixtures were added to and mixed well with the base grease, followed by milling with a three roll mill to produce grease compositions having a worked penetration of 250 to 350 (JIS K2220) and a dropping point of 260° C. or more (JIS K2220).

A grease composition that contains an aliphatic diurea (Example 13) as a thickener was prepared as follows. Predetermined amounts of raw material amines (octylamine and stearylamine, the molar ratio was octylamine:stearylamine=5:5) were reacted with 4.4′-diphenylmethane diisocyanate in a ratio of 2 moles of the raw material amines per mole of 4.4′-diphenylmethane diisocyanate in a base oil, followed by heating and cooling to obtain a base grease. Predetermined amounts of additives were mixed with the base oil, and the mixture was added to and mixed well with the base grease, followed by milling with a three roll mill to produce a grease composition having a worked penetration of 300 (JIS K2220) and a dropping point of 260° C. or more (JIS K2220).

A grease composition that contains a Li-complex soap (Example 14) as a thickener was prepared as follows. Azelaic acid and 12-hydroxystearic acid were inputted in a base oil. After heating, a lithium hydroxide aqueous solution was added, followed by heating again and cooling to obtain a base grease. Predetermined amounts of additives were mixed with the base oil, and the mixture was added to and mixed well with the base grease, followed by milling with a three roll mill to produce a grease composition having a worked penetration of 300 (JIS K2220) and a dropping point of 260° C. or more (JIS K2220).

Details of the components used for producing each grease are as follows.

### (a) Additives

Organic calcium sulfonate A: a calcium salt of highly basic alkyl benzenesulfonic acid (base number: 405)

Organic calcium sulfonate B: a calcium salt of dinonylnaphthalenesulfonic acid (base number: 0.26)

Organic zinc sulfonate A: a zinc salt of dinonylnaphthalenesulfonic acids (base number: 0.50)

Organic sodium sulfonate A: a sodium salt of alkyl naphthalene sulfonic acid (base number: 0.20)

Calcium carbonate A: CaCO₃ (average particle size 2 μm)

Aluminum carbonate A: Al₂(CO₃)₃ (average particle size 4 μm)

Note that the base numbers were values measured in accordance with JIS K 2501.

### (b) Base Oil

Synthetic hydrocarbon oil A: poly-α-olefin (40° C. kinematic viscosity; 62.1 mm²/s, 100° C.; 9.93 mm²/s, pour point: −60° C., viscosity index: 145)

Mineral oil A: refined mineral oil (40° C. kinematic viscosity; 102 mm²/s, 100° C.; 11.3 mm²/s, pour point: −12.5° C., viscosity index 97)

Mineral oil B: refined mineral oil (40° C. kinematic viscosity; 40.3 mm²/s, 100° C.; 6.24 mm²/s, pour point: −12.5° C., viscosity index 101)

Note that the kinematic viscosity of each base oil at 40° C. was measured in accordance with JIS K 2283. The pour point of each base oil was measured in accordance with JIS K 2269. The viscosity index was measured in accordance with JIS K 2283.

### (d) Antioxidant

Amine-based antioxidant A: alkyl diphenylamine (a reaction product of N-phenylbenzenamine and 2,4,4-trimethylpentene, Cas No. 68411-46-1)

### Test Method and Judgment

### Wear Resistance and Peel Resistance (FE8)

### Judgment Method

Tests were conducted with the FE8 endurance test using tapered roller bearings according to DIN 51819. The initial period 48 h of the operation out of the test time is assumed to be a break-in period. The test conditions are shown below.

Bearing form: 31312, one tapered roller bearing was mounted on each of the motor side and the non-motor side.

Test temperature: 160° C. (the test temperature during the break-in operation was room temperature.)

Test time: 500 h

Rotation speed: 750 rpm

Total amount of the grease: 400 cm³

Motor-side bearing, outer race: 25 cm³, inner race: 25 cm³, roller: 75 cm³,

Non-motor-side bearing, outer race: 25 cm³, inner race: 25 cm³, roller: 75 cm³,

Distance between the motor-side bearing and the non-motor-side bearing: 150 cm³

Test load: axial load 20 kN

Measured item: wear amount (g)

### Evaluation

The differences between the total mass of the outer race, the inner race, the roller, and the cage before the test and the total mass of the outer race, the inner race, the roller, and the cage after the test on the motor-side and the non-motor-side were calculated, and the average values thereof was used as a measurement result.

### Judgment

Total wear amount: 0.05 g or less . . . □ (passed)
0.10 g or less . . . ○ (passed)
0.10 g or more . . . x (failed)

### Torque Reduction (FE8)

### Evaluation Method

Tests were conducted with the FE8 endurance test using tapered roller bearings according to DIN 51819. The initial period 48 hours of the operation out of the test time is assumed to be a break-in period. The test conditions are shown below.

Bearing form: 31312, one pair of tapered roller bearings were mounted on each of the motor side and the non-motor side.

Test temperature: 160° C. (the test temperature during the break-in operation is room temperature)

Test time: 500 h

Rotation speed: 750 rpm

Total amount of the grease: 400 cm³

Motor-side bearing, outer race: 25 cm³, inner race: 25 cm³, roller: 75 cm³,

Non-motor-side bearing, outer race: 25 cm³, inner race: 25 cm³, roller: 75 cm³,

Distance between the motor-side bearing and the non-motor-side bearing: 150 cm³

Test load: axial load 20 kN

Measured item: bearing torque (Nm)

### Evaluation

The average value of the bearing torque for the last one hour of the test was calculated as a measurement value.

### Judgment

Bearing torque: 4.0 Nm or less . . . □ (passed)
5.0 Nm or less . . . ○ (passed)
5.0 Nm or more . . . x (failed)

### Low-Temperature Performance (Flow Pressure)

The fluidity of the grease compositions under a low temperature environment was evaluated in this test. The fluidity is involved in the cold start performance and the low-temperature fretting resistance.

### Evaluation Method

Tests were conducted with the flow pressure test according to DIN 51805. The test conditions are shown below.

Test temperature: −35° C.

Measured item: pressure (mbar)

### Evaluation

The pressure at which the grease flowed out was used as a flow pressure and as a measurement value.

### Judgment

Flow pressure: 1000 mbar or less . . . □ (passed)
1700 mbar or less . . . ○ (passed)
1700 mbar or more . . . x (failed)

### Overall Judgment

All of the evaluation on wear resistance and peel resistance, the evaluation on torque reduction, and the evaluation on low-temperature performance were passed: o (passed).

Any one of these evaluations was failed: x (failed).

TABLE 1

| | | | Examples | | | | | | |
|---|---|---|---|---|---|---|---|---|---|
| | | | 1 | 2 | 3 | 4 | 5 | 6 | 7 |
| (c) | Urea- | Alicyclic aliphatic diurea | 11 | 11 | 11 | 11 | 11 | 11 | 11 |
| Thickener | based | Aliphatic diurea | — | — | — | — | — | — | — |
| (% by | Soap- | Lithium-complex soap | — | — | — | — | — | — | — |
| mass) | based | | | | | | | | |

| | | | | | | | | | |
|---|---|---|---|---|---|---|---|---|---|
| (b) Base oil | Type | Synthetic | 100 | 100 | 100 | 100 | 100 | 100 | 100 |
| | (% by mass | hydrocarbon | | | | | | | |
| | relative to | oil A | | | | | | | |
| | the mass of | Mineral oil A | — | — | — | — | — | — | — |
| | the entire | Mineral oil B | — | — | — | — | — | — | — |
| | base oil) | | | | | | | | |

| | | | | | | | | |
|---|---|---|---|---|---|---|---|---|
| | Kinematic viscosity (40° C.) | 62 | 62 | 62 | 62 | 62 | 62 | 62 |
| | mm²/s | | | | | | | |
| | Viscosity index | 145 | 145 | 145 | 145 | 145 | 145 | 145 |
| | Pour point (° C.) | −60 | −60 | −60 | −60 | −60 | −60 | −60 |
| (a) Metal salt | Organic calcium sulfonate A | 1 | — | — | — | 0.5 | 4 | — |
| of organic | Organic calcium sulfonate B | — | 1 | — | — | — | — | — |
| sulfonic acid | Organic zinc sulfonate A | — | — | 1 | — | — | — | — |
| (% by mass) | Organic sodium sulfonate A | — | — | — | — | — | — | — |
| (a) Carbonate | Calcium carbonate A | — | — | — | 4 | — | — | 1 |
| (% by mass) | Aluminum carbonate A (for | — | — | — | — | — | — | — |
| | comparison) | | | | | | | |
| (d) Antioxidant | Amine-based antioxidant A | 2 | 2 | 2 | 2 | 2 | 2 | 2 |
| (% by mass) | | | | | | | | |

| Worked penetration | | 300 | 300 | 300 | 300 | 300 | 300 | 300 |
|---|---|---|---|---|---|---|---|---|
| Dropping point (° C.) | | 260< | 260< | 260< | 260< | 260< | 260< | 260< |
| Wear resistance and peel | Wear amount g | 0.02 | 0.06 | 0.06 | 0.02 | 0.04 | 0.02 | 0.03 |
| resistance | Judgment | ⊚ | ◯ | ◯ | ⊚ | ⊚ | ⊚ | ⊚ |
| FE8 (DIN 51819) | | | | | | | | |
| Torque reduction | Bearing toque (N · m) | 3.1 | 4.2 | 4.4 | 2.8 | 3.8 | 3.0 | 3.5 |
| FE8 (DIN 51819) | Judgment | ⊚ | ◯ | ◯ | ⊚ | ⊚ | ⊚ | ⊚ |
| Low-temperature | Flow pressure | 660 | 680 | 670 | 660 | 660 | 680 | 650 |
| performance | (mbar @−35° C.) | | | | | | | |
| Flow pressure | Judgment | ⊚ | ⊚ | ⊚ | ⊚ | ⊚ | ⊚ | ⊚ |
| (DIN 51819) | | | | | | | | |

| Overall judgment | | | ◯ | ◯ | ◯ | ◯ | ◯ | ◯ | ◯ |
|---|---|---|---|---|---|---|---|---|---|
| | | | Examples | | | | | | |
| | | | 8 | 9 | 10 | 11 | 12 | 13 | 14 |
| (c) | Urea- | Alicyclic aliphatic diurea | 11 | 11 | 11 | 11 | 11 | — | — |
| Thickener | based | Aliphatic diurea | — | — | — | — | — | 11 | — |
| (% by | Soap- | Lithium-complex soap | — | — | — | — | — | — | 13 |
| mass) | based | | | | | | | | |

| | | | | | | | | | |
|---|---|---|---|---|---|---|---|---|---|
| (b) Base oil | Type | Synthetic | 100 | 100 | 100 | 40 | 80 | 100 | 100 |
| | (% by mass | hydrocarbon | | | | | | | |
| | relative to | oil A | | | | | | | |
| | the mass of | Mineral oil A | — | — | — | 30 | 20 | — | — |
| | the entire | Mineral oil B | — | — | — | 30 | — | — | — |
| | base oil) | | | | | | | | |

| | | | | | | | | |
|---|---|---|---|---|---|---|---|---|
| | Kinematic viscosity (40° C.) | 62 | 62 | 62 | 62 | 75 | 62 | 62 |
| | mm²/s | | | | | | | |
| | Viscosity index | 145 | 145 | 145 | 110 | 135 | 145 | 145 |
| | Pour point (° C.) | −60 | −60 | −60 | −25 | −40 | −60 | −60 |
| (a) Metal salt | Organic calcium sulfonate A | — | 1 | 1 | 1 | 1 | 1 | 1 |
| of organic | Organic calcium sulfonate B | — | — | — | — | — | — | — |
| sulfonic acid | Organic zinc sulfonate A | — | — | — | — | — | — | — |
| (% by mass) | Organic sodium sulfonate A | — | — | — | — | — | — | — |
| (a) Carbonate | Calcium carbonate A | 6 | — | — | — | — | — | — |
| (% by mass) | Aluminum carbonate A (for | — | — | — | — | — | — | — |
| | comparison) | | | | | | | |
| (d) Antioxidant | Amine-based antioxidant A | 2 | 2 | 2 | 2 | 2 | 2 | 2 |
| (% by mass) | | | | | | | | |

| Worked penetration | | 300 | 250 | 350 | 300 | 300 | 300 | 300 |
|---|---|---|---|---|---|---|---|---|
| Dropping point (° C.) | | 260< | 260< | 260< | 260< | 260< | 260< | 260< |
| Wear resistance and peel | Wear amount g | 0.02 | 0.03 | 0.02 | 0.06 | 0.04 | 0.06 | 0.05 |
| resistance | Judgment | ⊚ | ⊚ | ⊚ | ◯ | ⊚ | ◯ | ◯ |
| FE8 (DIN 51819) | | | | | | | | |
| Torque reduction | Bearing toque (N · m) | 2.9 | 3.9 | 2.7 | 4.1 | 3.8 | 4.1 | 4.2 |
| FE8 (DIN 51819) | Judgment | ⊚ | ⊚ | ⊚ | ◯ | ⊚ | ◯ | ◯ |
| Low-temperature | Flow pressure | 690 | 950 | 590 | 1550 | 900 | 670 | 680 |
| performance | (mbar @−35° C.) | | | | | | | |
| Flow pressure | Judgment | ⊚ | ⊚ | ⊚ | ◯ | ⊚ | ⊚ | ⊚ |
| (DIN 51819) | | | | | | | | |

| | | | | | | | |
|---|---|---|---|---|---|---|---|
| Overall judgment | ◯ | ◯ | ◯ | ◯ | ◯ | ◯ | ◯ |

| | | | Comparative Examples | | | |
|---|---|---|---|---|---|---|
| | | | 1 | 2 | 3 | 4 |
| (c) | Urea- | Alicyclic aliphatic diurea | 11 | 11 | 11 | 11 |
| Thickener | based | Aliphatic diurea | — | — | — | — |
| (% by | Soap- | Lithium-complex soap | — | — | — | — |
| mass) | based | | | | | |

| | | | | | | |
|---|---|---|---|---|---|---|
| (b) Base oil | Type | Synthetic | 100 | 100 | 30 | 100 |
| | (% by mass | hydrocarbon | | | | |
| | relative to | oil A | | | | |
| | the mass of | Mineral oil A | — | — | 35 | — |
| | the entire | Mineral oil B | — | — | 35 | — |
| | base oil) | | | | | |

| | | | | | |
|---|---|---|---|---|---|
| | Kinematic viscosity (40° C.) | 62 | 62 | 62 | 62 |
| | mm²/s | | | | |
| | Viscosity index | 145 | 145 | 105 | 145 |
| | Pour point (° C.) | −60 | −60 | −17.5 | −60 |
| (a) Metal salt | Organic calcium sulfonate A | — | — | 1 | 1 |
| of organic | Organic calcium sulfonate B | — | — | — | — |
| sulfonic acid | Organic zinc sulfonate A | — | — | — | — |
| (% by mass) | Organic sodium sulfonate A | 1 | — | — | — |
| (a) Carbonate | Calcium carbonate A | — | — | — | — |
| (% by mass) | Aluminum carbonate A (for | — | 1 | — | — |
| | comparison) | | | | |
| (d) Antioxidant | Amine-based antioxidant A | 2 | 2 | 2 | — |
| (% by mass) | | | | | |

| Worked penetration | | 300 | 300 | 300 | 300 |
|---|---|---|---|---|---|
| Dropping point (° C.) | | 260< | 260< | 260< | 260< |
| Wear resistance and peel | Wear amount g | 0.14 | 0.15 | 0.08 | 0.32 |
| resistance | Judgment | X | X | ◯ | X |
| FE8 (DIN 51819) | | | | | |
| Torque reduction | Bearing toque (N · m) | 6.3 | 6.5 | 4.5 | 5.2 |
| FE8 (DIN 51819) | Judgment | X | X | ◯ | X |
| Low-temperature | Flow pressure | 680 | 690 | 1800< | 660 |
| performance | (mbar @−35° C.) | | | | |
| Flow pressure | Judgment | ⊚ | ⊚ | X | ⊚ |
| (DIN 51819) | | | | | |

| | | | | |
|---|---|---|---|---|
| Overall judgment | X | X | X | X |

As shown in Table 1, it is understood that the lubricant compositions of Examples 1 to 14 of the present invention, each of which contained an organic metallic salt or inorganic metallic salt having a metallic group having a valence of 2 as an additive, were thus favorable in wear resistance and peel resistance as well as torque reduction as compared with Comparative Example 1, which contained an organic metallic salt having a metallic group having a valence of 1 as an additive, and Comparative Example 2, which contained an inorganic metallic salt having a metallic group having a valence of 3. In addition, it is understood that the lubricant compositions of Examples 1 to 14 of the present invention, which each contained a synthetic oil in a certain proportion, were thus favorable in low-temperature performance as compared with Comparative Example 3, which contained no synthetic oil. Moreover, it is understood that the lubricant compositions of Examples 1 to 14 of the present invention, which each contained an antioxidant, were thus favorable in wear resistance and peel resistance as compared with Comparative Example 4, which contained no antioxidant.

1. A grease composition for a tapered roller bearing, comprising:
(a) at least one compound selected from the group consisting of metallic salts each having a metallic group having a valence of 2 as an additive;
(b) a base oil containing a synthetic oil having a viscosity index of 110 or more and a pour point of −35° C. or less in an amount of 40% or more of the entire base oil;
(c) a thickener; and
(d) an antioxidant.

2. The grease composition for a tapered roller bearing according to claim 1, wherein the component (a) is represented by the following formula (1) or (2):
[R4—SO₃]M¹ (1)
wherein R4 represents an alkyl group, an alkenyl group, an alkyl naphthyl group, a dialkyl naphthyl group, an alkyl phenyl group, and a petroleum high boiling point fraction residue, the alkyl or alkenyl is linear or branched and has 2 to 22 carbon atoms, and M¹ represents an alkaline earth metal or zinc, and
M²CO₃ (2)
wherein M² represents an alkaline earth metal or zinc.

3. The grease composition for a tapered roller bearing according to claim 1, wherein the component (a) is at least one selected from the group consisting of organic calcium sulfonates, organic zinc sulfonates, calcium carbonate, and zinc carbonate.

4. The grease composition for a tapered roller bearing according to claim 1, wherein the synthetic oil contained in the component (b) is at least one selected from the group consisting of synthetic hydrocarbon oils.

5. The grease composition for a tapered roller bearing according to claim 1, wherein a kinematic viscosity of the synthetic oil contained in the component (b) at 40° C. is 15 to 5000 mm²/s, and
a kinematic viscosity of the entire component (b) at 40° C. is 20 to 300 mm²/s.

6. The grease composition according to claim 1, wherein the component (c) is at least one selected from the group consisting of urea compounds and Li soap-based compounds.

7. The grease composition for a tapered roller bearing according to claim 6, wherein the urea compound is a diurea compound represented by the following formula (3):
R1—NHCONH—R2—NHCONH—R3 (3)
wherein R2 represents a divalent aromatic hydrocarbon group having 6 to 15 carbon atoms, R1 and R3 may be the same or different and each represent an alkyl group having 6 to 30 carbon atoms or a cyclohexyl group, and the proportion of the number of moles of the cyclohexyl groups to the total number of moles of the cyclohexyl groups and the alkyl groups [{(the number of the cyclohexyl groups)/(the number of the cyclohexyl groups+the number of the alkyl groups)}×100] is 0 to 90% by mol.

8. The grease composition for a tapered roller bearing according to claim 6, wherein the Li soap-based compound is a Li complex that is a mixture of a lithium salt of at least one diprotic acid selected from succinic acid, malonic acid, adipic acid, pimelic acid, azelaic acid, and sebacic acid and a lithium salt of at least one aliphatic carboxylic acid.

9. The grease composition according to claim 1, wherein the (d) antioxidant contains at least one selected from the group consisting of amine-based antioxidants and phenol-based antioxidants.

10. The grease composition according to claim 1, wherein the antioxidant is at least one selected from the group consisting of alkyl diphenylamines, N-phenyl-α-naphthylamine, 3-(4′-hydroxy-3′,5′-di-tert-butylphenyl)propionic acid-n-octadecyl, 2,6-di-tertiary-butyl-p-cresol (BHT), 2,2′-methylenebis(4-methyl-6-tertiary-butylphenol), 4,4′-butylidenebis(3-methyl-6-tertiary-butylphenol), 2,6-di-tertiary-butyl-phenol, 2,4-dimethyl-6-tertiary-butylphenol, tertiary-butylated hydroxyanisole (BHA), 4,4′-butylidenebis(3-methyl-6-tertiary-butylphenol), 4,4′-methylenebis(2,3-di-tertiary-butylphenol), and 4,4′-thiobis(3-methyl-6-tertiary-butylphenol).

11. The grease composition for a tapered roller bearing according to claim 1, wherein a dropping point of the grease composition for a tapered roller bearing is 230° C. or more.
